(19) United States
(12) Patent Application Publication
(10) Pub. No.: US 2026/0194405 A1
(43) Pub. Date: Jul. 9, 2026

(54) DEVICES FOR CHARACTERIZING THE RESPONSE OF PRESSURE MEASUREMENT SYSTEMS

(71) Applicant: UNIVERSITY OF WYOMING, Laramie, WY (US)

(72) Inventors: Pourya NIKOUEEYAN, Laramie, WY (US); John STRIKE, Laramie, WY (US); Michael HIND, Laramie, WY (US); Jonathan NAUGHTON, Laramie, WY (US)

(21) Appl. No.: 18/868,647

(22) PCT Filed: Jun. 1, 2023
(86) PCT No.: PCT/US2023/024159

§ 371 Date: Nov. 22, 2024

Related U.S. Application Data
(60) Provisional application No. 63/348,899, filed on Jun. 3, 2022.

(51) Int. Cl. G01L 19/00; G01L 27/00

(52) U.S. Cl. CPC G01L 19/003; G01L 27/002

(57) ABSTRACT

Embodiments described herein generally relate to devices for dynamic pressure sensing characterization and methods of use. In an embodiment, a device to dynamically characterize a pressure measurement system is provided. The device includes a pneumatic passage comprising a front end, a back end, an interior, and a flow path. The device further includes a valve coupled to the back end of the pneumatic passage, the valve for permitting a regulated fluid to enter the flow path of the pneumatic passage. The device further includes a reference pressure sensing element disposed on the interior of the pneumatic passage and along the flow path of the pneumatic passage. The device further includes a controller coupled to the reference pressure sensing element and the valve. Methods for characterizing a dynamic response of a pressure sensing system are also provided.

### BACKGROUND

### Field

Embodiments described herein generally relate to devices for characterizing the response of pressure measurement systems and to methods of use.

### Description of the Related Art

Pressure sensors that convert pressure changes to electrical signals are often used in pressure measurement applications. A pressure sensor (or transducer) is equipped with a sensing element that converts mechanical pressure from fluids to an electrical signal. Pressure sensors have numerous applications including, for example, aerodynamic pressure sensing and propulsion pressure sensing, and process control pressure sensing. In many applications, it is necessary or can be beneficial to mount the pressure transducer away from the measurement point by tubing. At one end of the tubing is a surface port mountable to the article (for example, an aerodynamic surface) being measured and at the other end of the tubing is the pressure transducer. Such tubing provides isolation of the pressure transducer from contamination (dust, debris, and water), excessive heat, electric discharge, strains imposed by the mounting hole, and physical contact with the measurement point. However, the tubing causes pneumatic distortions such as time lag and amplitude attenuation/resonance between the surface port and the pressure transducer. Such distortions limit the usefulness of pressure measurements to averaged, steady data only.

There is a need for new and improved devices for characterizing the dynamic response of pressure sensors and tubing systems.

### SUMMARY

Embodiments described herein generally relate to devices for characterizing the response of pressure measurement systems and to methods of use. Embodiments of the present disclosure can be used for the characterization of dynamic and transient pressure sensing systems.

In an embodiment, a device to dynamically characterize a pressure measurement system is provided. The device includes a pneumatic passage comprising a front end, a back end, an interior, and a flow path. The device further includes a valve coupled to the back end of the pneumatic passage, the valve for permitting a regulated fluid to enter the flow path of the pneumatic passage. The device further includes a reference pressure sensing element disposed on the interior of the pneumatic passage and along the flow path of the pneumatic passage. The device further includes a controller coupled to the reference pressure sensing element and the valve.

In another embodiment, a device for performing dynamic pressure characterization is provided. The device includes a pneumatic passage adapted to be coupled to a test article, the test article having a pressure sensor, the pneumatic passage comprising a front end, a back end, and an interior, the interior of the pneumatic passage comprising a flow path. The device further includes a valve coupled proximate to the back end of the pneumatic passage; and a source of regulated fluid in fluid communication with the pneumatic passage and the valve. The device further includes a reference pressure sensing element disposed on the interior of the pneumatic passage and along the flow path between the front end and the back end of the pneumatic passage. The device further includes a controller configured to: receive a reference pressure signal from the reference pressure sensing element, the reference pressure signal corresponding to a pressure of the regulated fluid; receive an uncalibrated pressure signal from the pressure sensor of the test article; and determine a calibrated pressure or dynamically characterized pressure based on the reference pressure signal and the uncalibrated pressure signal.

In another embodiment, a method for characterizing a dynamic response of a pressure sensing system is provided. The method includes coupling a pressure characterization device to a test article by a pneumatic passage, wherein: the test article comprises the pressure sensing system, the pressure sensing system comprising a pressure sensor; and the pressure characterization device comprises: the pneumatic passage, the pneumatic passage comprising a front end, a back end, and an interior; and a pressure transducer disposed on the interior of the pneumatic passage. The method further includes delivering a pulse of regulated fluid to the interior of the pneumatic passage, the regulated fluid having a reference pressure. The method further includes measuring the reference pressure using the pressure transducer; and measuring the uncalibrated pressure using the pressure sensor of the test article. The method further includes determining a calibrated pressure or dynamically characterized pressure based on the uncalibrated pressure and the reference pressure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A illustrates at least one underlying problem embodiments described herein can address.

FIG. 1B shows an illustration of two signal curves measured by devices described herein according to at least one embodiment of the present disclosure.

FIG. 2A shows a schematic diagram of a device for characterizing the dynamic response of a pressure measurement system according to at least one embodiment of the present disclosure.

FIGS. 2B and 2C show example pressure curves collected using a device for characterizing the dynamic response of a pressure measurement system according to at least one embodiment of the present disclosure.

FIG. 3A is a perspective view of an example nozzle assembly of a device for characterizing the dynamic response of a pressure measurement system according to at least one embodiment of the present disclosure.

FIG. 3B is a perspective view of the example nozzle assembly shown in FIG. 3A according to at least one embodiment of the present disclosure.

FIG. 3C is a cross-sectional view of the example nozzle assembly shown in FIG. 3A according to at least one embodiment of the present disclosure.

FIG. 4A is a partially exploded side view of an example nozzle assembly of a device for characterizing the dynamic response of a pressure measurement system according to at least one embodiment of the present disclosure.

FIG. 4B is a partially exploded perspective view of the example nozzle assembly shown in FIG. 4A according to at least one embodiment of the present disclosure.

FIG. 4C is a partially exploded perspective view of the example nozzle assembly shown in FIG. 4A according to at least one embodiment of the present disclosure.

FIG. 5A is a partial cross-sectional view of an example device for characterizing the dynamic response of a pressure measurement system according to at least one embodiment of the present disclosure.

FIG. 5B is a partial cross-sectional view of an example device for characterizing the dynamic response of a pressure measurement system according to at least one embodiment of the present disclosure.

FIG. 6 is an illustration of an example device for characterizing the dynamic response of a pressure measurement system in operation according to at least one embodiment of the present disclosure.

FIGS. 7A and 7B show exemplary data collected by operation of a device for characterizing the dynamic response of a pressure measurement system according to at least one embodiment of the present disclosure.

FIG. 8A shows selected operations of a method for characterizing a dynamic response of a pressure sensing system according to at least one embodiment of the present disclosure.

FIG. 8B shows selected operations of a method for characterizing a dynamic response of a pressure sensing system according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to devices for characterizing the response of pressure measurement systems and to methods of use. Embodiments of the present disclosure can be used for the characterization of dynamic and transient pressure sensing systems. Relative to conventional technologies, devices described herein can enable improved pressure measurements of test articles and can be used to calibrate, correct, or otherwise determine pressure dynamically. Devices described herein can also enable improved pressure measurements of any suitable article where a dynamic or static pressure is measured remotely and accurate time-dependent pressure is required.

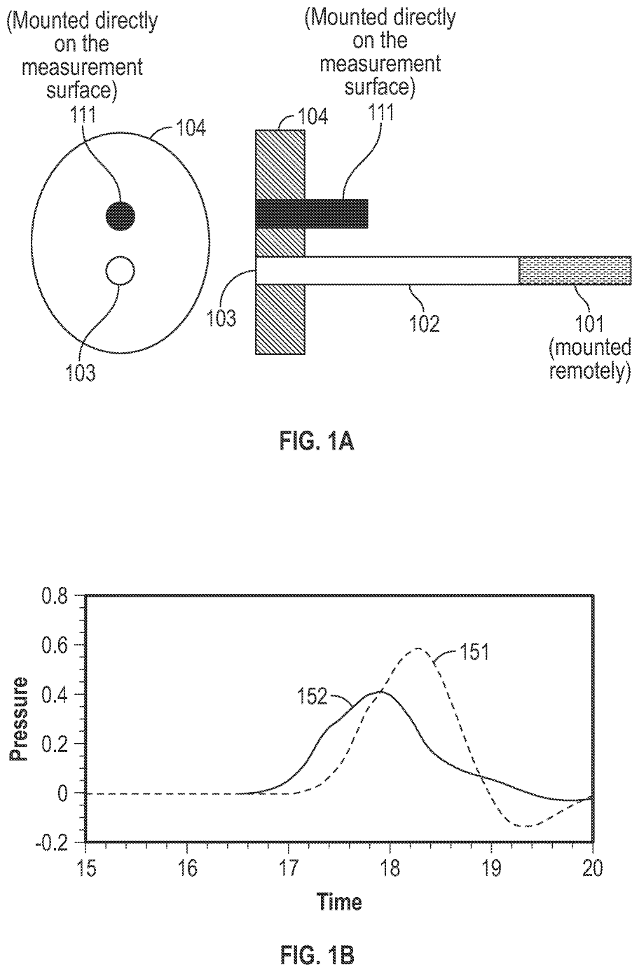

As described above, and shown in FIG. 1A, conventional technologies use a remotely located pressure transducer 101 for pressure sensing and measurement utilizing a tubing 102 to isolate the pressure transducer from the measurement point of the measurement surface 104. Such isolation is performed to keep the expensive and sensitive pressure sensor (for example, pressure transducer 101) away from heat, humidity, contamination, shock, strains imposed by the mounting hole, and physical contact with the measurement point. At one end of the tubing 102 is a surface port 103 mountable to a measurement surface 104 of an article (for example, an aerodynamic surface such as aircraft wing or a flap) being measured and at the other end of the tubing 102 is the pressure sensor (for example, pressure transducer 101). The tubing 102, however, causes pneumatic distortions such as time lag and amplitude attenuation/resonance between the surface port 103 and the pressure transducer 101, among other distortions shown by a signal 151 in FIG. 1B. That is, the remotely mounted sensor (for example, pressure transducer 101) is measuring a distorted signal because of the distortions introduced by the tubing 102. Such distortions limit the usefulness of conventional pressure measurements to averaged, steady data only.

In contrast, when a transducer 111 is mounted directly on the measurement surface 104, those distortions introduced by the tubing 102 are not present giving rise to signal 152. These two signals can be delivered to an algorithm that can determine, for example, a geometry of the tubing 102 and other parameters that derive/model this distortion behavior of the tubing 102. To characterize the dynamic response of the system, and in some embodiments, devices described herein measure two signals simultaneously: (1) the signal 152 at the measurement surface 104 as measured with a transducer 111 (a reference transducer) of devices described herein; and the distorted pressure signal (for example, signal 151) at the end of the tubing 102 measured by pressure transducer 101 (a third-party pressure transducer).

Embodiments described herein can enable or allow the characterization of the frequency response of a pressure measurement system to be utilized to compensate for the pneumatic distortions, enabling precise measurements needed for engineering applications. The device can account for or compensate for such distortions mathematically. Moreover, conventional technologies for pressure sensing and measurement are not portable. In contrast, embodiments described herein are portable and enable tailoring of the pressure characterization signal (for example, amplitude and duration).

Embodiments of the device for characterizing the dynamic response of a pressure measurement system can be used in real sensor characterization applications. The device can be compact and portable, and can be implemented in a variety of ways such as handheld devices and bench-top/cart-top devices. Embodiments described herein can be utilized in a variety of applications such as any suitable application where pressure measurements are performed on test articles. Test articles include, but are not limited to, aircraft, landcraft, watercraft, wind turbine and gas turbine blades. Moreover suitable applications include, but are not limited to, aerodynamic pressure sensing, process control pressure sensing wake and jet flow pressure and velocity sensing, air data (angle of attack, angle of sideslip, Mach number, among others) and pressure sensing. Generally, devices described herein can enable pressure measurements of any suitable article where a dynamic pressure is measured remotely and accurate time-dependent pressure is required.

Generally, and in some examples, devices described herein include a pneumatic signal shaper, a source of regulated fluid (such as compressed air, negative gauge pressure (vacuum) or pressure fluctuation created by means of piezoelectric devices), one or more pneumatic passages, and a reference pressure sensing element (such as a transducer) that measures a pressure signal. The pneumatic signal shaper, such as a valve, generates a characterization pressure signal of sufficient amplitude and duration. The characterization pressure signal is passed through a pneumatic passage of the device and measured using the reference pressure sensing element of the device. The characterization pressure signal serves as a reference pressure signal, for example, signal 152. To use devices described herein, the device is coupled to a sensing system to be characterized of a test article such as an aerodynamic surface (for example, aircraft wing or flap). The sensing system to be characterized has a pressure sensor or a length of tubing (for example, tubing 102) that connects the location to be measured with a pressure sensor. Depending on the nature of the sensing system to be characterized, the pressure signal (also referred to as an uncalibrated or uncorrected pressure signal, for example, signal 151) experiences pneumatic distortions such as lag, attenuation, and amplification.

As described herein, comparing the two measurements—the characterization pressure signal (also referred to as the reference pressure signal) and the uncalibrated pressure signal—can allow for more precise characterization of the sensing system of the test article.

Other illustrative, but non-limiting, uses for devices described herein can range from purging system with a brief pulse of air, and testing to see if sensing system is operating correctly (for example, checking to see if tubing in the system leaks or if it is blocked).

Devices described herein can also be utilized for static calibration. Static calibration is a process by which the sensor electrical signal is adjusted so that it has a known relationship to the applied pressure. In some instances, the pressure sensor within the test article is not easily accessible by conventional technologies and cannot be statically calibrated by conventional technologies. However, the device described herein can be used to apply a constant pressure (the value is known through the reference pressure sensor) to the remotely mounted sensor and extract a static calibration equation.

Embodiments described herein generally relate to devices for characterizing the response of pressure measurement systems and to methods of use. Embodiments of the present disclosure can be used for the characterization of dynamic and transient pressure sensing systems. The devices can enable, for example, calibration or characterization of the tubing (for example, tubing 102) used in conventional pressure measurement systems to isolate the pressure transducer from the measurement point.

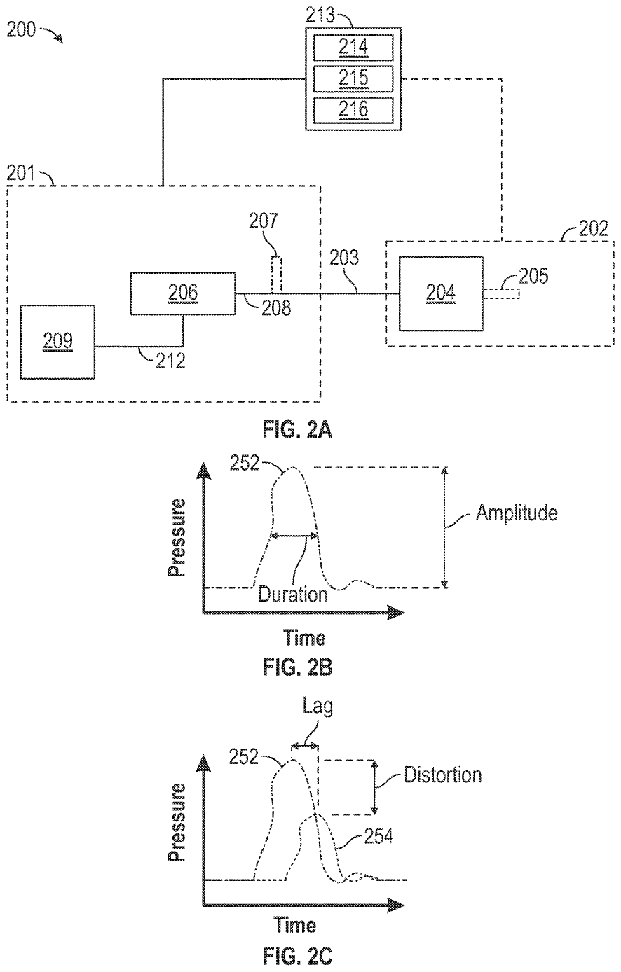

FIG. 2A shows a schematic diagram 200 of device 201 for characterizing the dynamic response of a pressure measurement system of a test article 202 according to at least one embodiment of the present disclosure. The device 201 of FIG. 2A includes a pneumatic signal generator 206 coupled to a reference pressure sensing element 207 (such as a reference pressure transducer) positioned along a pneumatic passage 208 (such as a channel, a tube, or similar structure). The device 201 also includes a source of regulated fluid (such as compressed air, negative gauge pressure (vacuum), or pressure fluctuation created by means of piezoelectric devices).

When compressed air is utilized with embodiments described herein, the source 209 of regulated fluid (in this example, compressed fluid) can include a compressor. The source 209 of regulated fluid contains the fluid, such as air, that is compressed. The source 209 of regulated fluid includes in this example a compressor that serves to pressurize the regulated fluid. The source 209 of regulated fluid can be of any suitable size.

Although embodiments of the present disclosure are described with reference to a source of compressed fluid, a compressed fluid, and compressed air, it should be understood that any suitable regulated fluid and source thereof can be utilized with embodiments described herein such as compressed air, negative gauge pressure (vacuum), pressure fluctuation created by means of piezoelectric devices, among others.

For example, when negative air pressure is utilized with embodiments described herein, the source 209 of regulated fluid can include a vacuum.

The source 209 of regulated fluid is coupled to, or in fluid communication with, the pneumatic signal generator 206. The pneumatic signal generator 206 includes one or more components to produce or generate a characterization pressure signal such as a high-frequency pneumatic signal. The one or more components of the pneumatic signal generator 206 can include a pressure regulator, a solenoid valve, an electric valve, an actuator, or other suitable components. The pneumatic signal generator 206 can be any suitable element that initiates or dynamically controls a fluid pressure signal. The characterization pressure signal can be shaped in any suitable way, such as, by the use of one or more small-volume, fast-acting valves, piezoelectric actuators, or solenoids. For example, when pressure fluctuations are utilized with embodiments described herein, the source 209 of regulated fluid can include a piezoelectric device. The pneumatic signal generator 206 can be referred to as a pressure regulator, a valve, a solenoid valve, an electric valve, an actuator.

In addition, the pneumatic signal generator 206 can be adapted to send/receive signals to a source 209 of regulated fluid. The source 209 of regulated fluid is in fluid communication with the pneumatic passage 208 by, for example, the one or more components of the pneumatic signal generator 206 such as a pressure regulator, a solenoid valve, an electric valve, or an actuator.

The characterization pressure signal (such as the high-frequency pneumatic signal) generated by the pneumatic signal generator 206 can cause a pressure wave (or series of waves, or flow) of regulated fluid (such as a pulse of compressed air) to enter an interior of the pneumatic passage 208.

The pneumatic signal generator 206 is coupled to, or in fluid communication with, a reference pressure sensing element 207 (for example, a fast-response pressure transducer). The characterization pressure signal can be measured using the reference pressure sensing element 207, and the characterization pressure signal measured serves as a reference signal (or reference pressure). For example, and in use, regulated fluid exiting the source 209 of regulated fluid is delivered through pneumatic passage 212 and to pneumatic passage 208, via one or more components of the pneumatic signal generator 206. Various components of the device 201 can be coupled to a controller 213.

The controller 213 can allow a user to gain access to and operate the device 201, the test article 202, or combinations thereof. The controller 213 includes a processor 214, memory 215, and support circuits 216. The processor 214 may be one of any form of general purpose microprocessor, or a general purpose central processing unit (CPU), each of which can be used in an industrial setting, such as a programmable logic controller (PLC), supervisory control and data acquisition (SCADA) systems, or other suitable industrial controller. The memory 215 is non-transitory and may be one or more of readily available memory such as random access memory (RAM), read only memory (ROM), or any other form of digital storage, local or remote. The memory 215 contains instructions, that when executed by the processor, facilitate the operation of the device 201, the test article 202, or both of FIG. 2, and operations of the device 201, the test article 202, or both. The instructions in the memory 215 can be in the form of a program product such as a program that implements the method of the present disclosure. The program code of the program product may conform to any one of a number of different programming languages. Illustrative, but non-limiting, examples of computer-readable storage media include: (i) non-writable storage media (for example, read-only memory devices within a computer such as CD-ROM disks readable by a CD-ROM drive, flash memory, ROM chips, or any type of solid-state non-volatile semiconductor memory) on which information is permanently stored; and (ii) writable storage media (for example, floppy disks within a diskette drive or hard-disk drive or any type of solid-state random-access semiconductor memory) on which alterable information is stored. Such computer-readable storage media, when carrying computer-readable instructions that direct the functions of the methods described herein, are examples of the present disclosure. In one example, embodiments of the disclosure may be implemented as the program product stored on a computer-readable storage media (for example, memory) for use with a computer system (not shown). The program(s) of the program product define functions of the disclosure, described herein.

The device 201 is coupled to the test article 202 via nozzle tip 203 (for example, nozzle tip 312). Although not shown in FIG. 2A, the pneumatic passage 208 extends through nozzle tip 203 such that the pneumatic passage 208 can be in fluid communication with the test article 202. The test article 202 includes a sensing system to be characterized 204 such as a pressure sensor. In use, and as shown in FIG. 2A, the pneumatic passage 208 is also in fluid communication with the sensing system to be characterized 204. The sensing system to be characterized 204 includes a sensor 205 (for example, a transducer) positioned some distance away from a pressure measurement point by, for example, a tubing (for example, tubing 102). As described above, conventional technologies for measuring the pressure of a test article (such as an aerodynamic surface) includes a pressure sensor positioned a distance away from the measurement point by the tubing (for example, tubing 102). The tubing, however, introduces pneumatic distortions in the form of, for example, time lag, resonance, attenuation, or combinations thereof, among others. Such pneumatic distortions provide unreliable pressure measurements for the test article.

The inventors found that a device 201 that can be used to characterize the dynamic response, or calibrate the pressure transducer, to measure the “real” pressure on the surface of the test article. A graph of pressure as a function of time for the pressure measurements output using the reference pressure sensing element 207 of the device 201 is shown in FIG. 2B as curve 252. As shown in FIG. 2B, the curve 252 is characterized by a duration and an amplitude. A graph of pressure as a function of time for the pressure measurements of sensor 205 is shown in FIG. 2B as curve 254. Curve 254 also is characterized by a duration and an amplitude. The difference between an approximate midpoint of the durations of curves 252 and 254 represents a time lag, while the amplitude differences between curves 252 and 254 represent distortions such as resonance and attenuation.

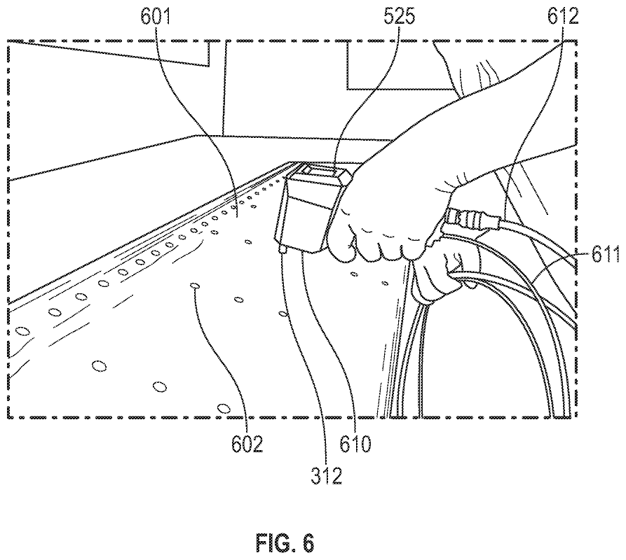

As shown in the illustration of FIG. 6, further described below, the test article 202 (shown as test article 601 in FIG. 6) is an aerodynamic surface (for example, an aircraft wing or flap)) that includes pressure taps. With respect to the test article, the terms “pressure tap” and “surface port” are used interchangeably. The device 201 (for example, shown as a hand-held device 610 in FIG. 6) is coupled to the test article 202 (for example, test article 601 in FIG. 6) via placement of the nozzle tip 203 (for example, nozzle tip 312 in FIG. 6) over a pressure tap of the test article 202.

The device 201 of FIG. 2A includes a nozzle assembly, among other components, as described below.

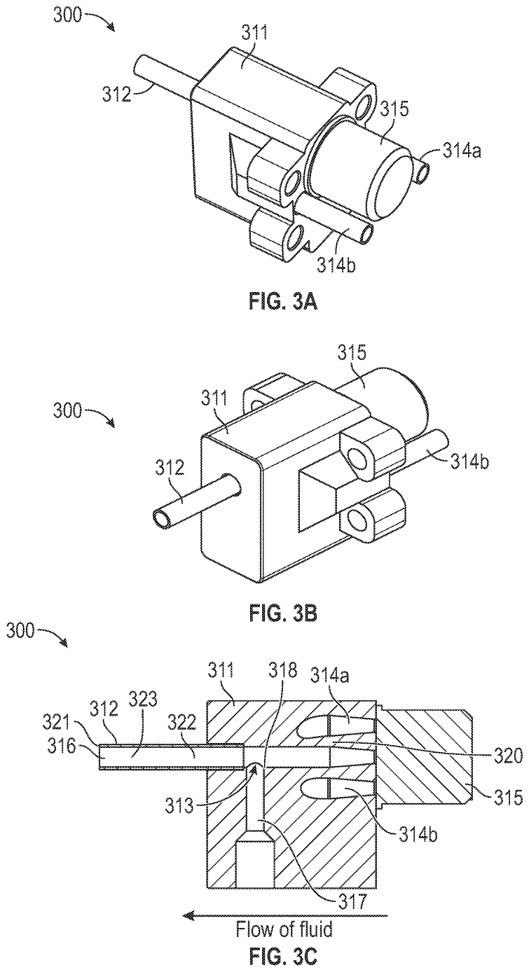

FIGS. 3A-3C are perspective views of a nozzle assembly 300 of a device for characterizing the dynamic response of a pressure measurement system according to at least one embodiment of the present disclosure. The nozzle assembly 300 can be utilized with any suitable embodiment described herein, such as device 201, device 500, device 550, and hand-held device 610.

The nozzle assembly 300 includes a nozzle housing 311 which contains a pneumatic signal generator 315 (for example, pneumatic signal generator 206) and a nozzle tip 312 (for example, nozzle tip 203). A pneumatic passage 316 (for example, a channel or a tube) extends from the pneumatic signal generator 315 through the nozzle housing 311 and to the nozzle tip 312. At least a portion of the pneumatic passage 316 is disposed within the nozzle tip 312. Pneumatic passage 316 can correspond to pneumatic passage 208 of, for example, FIG. 2A. The nozzle tip 312 is adapted or configured to be coupled, directly or indirectly, to a sensing system to be characterized (not shown in FIGS. 3A-3C; shown in, for example, FIG. 2A as the sensing system to be characterized 204). The nozzle tip 312 can be made of, for example, metal, plastic, or other suitable material.

The pneumatic passage 316 includes an interior wall 318, a back end 320, a front end 321, and an interior 322. The interior 322 of the pneumatic passage 316 comprises a flow path 323 through which a regulated fluid passes or flows.

The pneumatic signal generator 315 comprises or is one or more components to produce or generate a characterization pressure signal such as a high-frequency pneumatic signal. The one or more components of the pneumatic signal generator 315 can include a pressure regulator, a solenoid valve, an electric valve, an actuator, or other suitable components. The pneumatic signal generator 315 can be any suitable element that initiates or dynamically controls a fluid pressure signal. The pneumatic signal generator 315 (or valve or actuator thereof) is coupled to the back end 320 of the pneumatic passage 316. The pneumatic signal generator 315 (or valve or actuator thereof) permits a regulated fluid to enter the flow path 323 of the pneumatic passage 316. The pneumatic signal generator 315 can be referred to as a pressure regulator, a valve, a solenoid valve, an electric valve, an actuator.

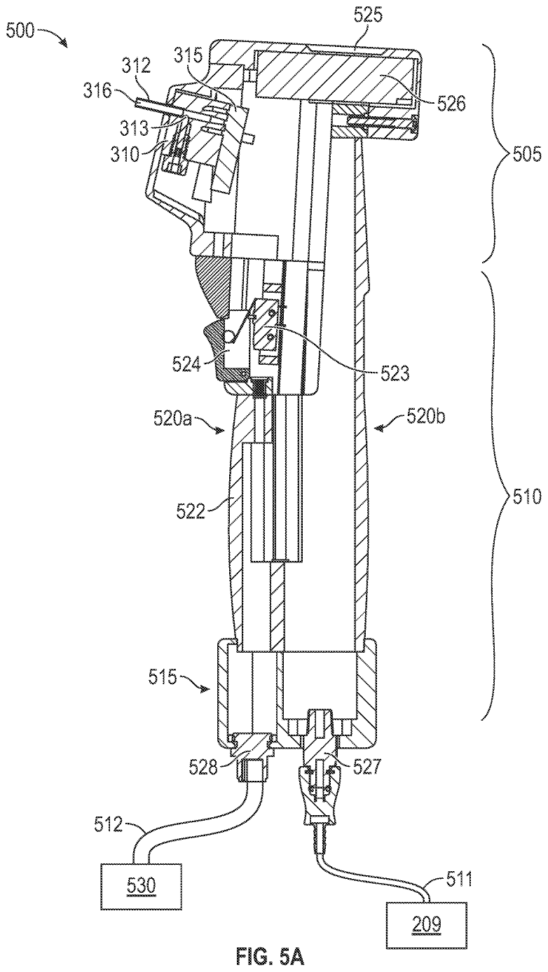

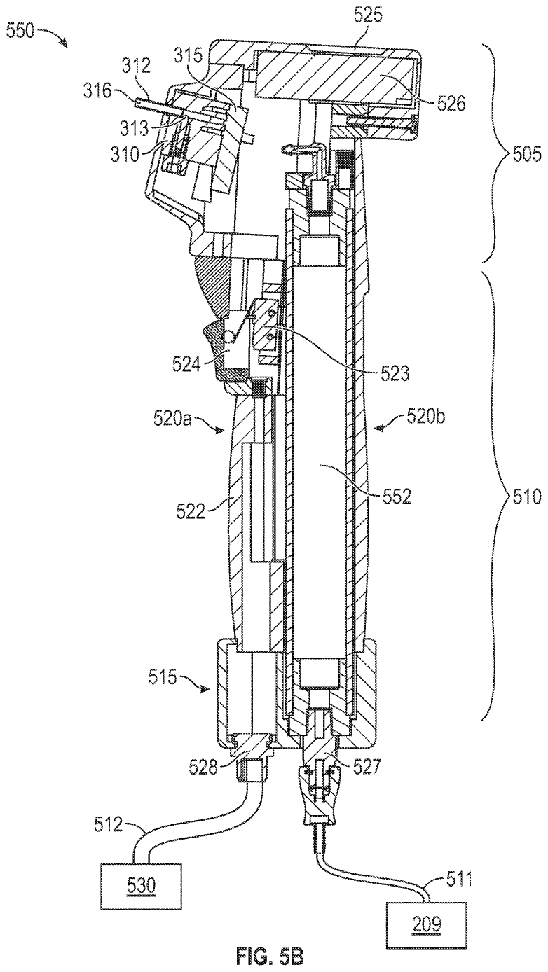

The characterization pressure signal can be shaped in any suitable way, such as, by the use of one or more small-volume, fast-acting valves, piezoelectric actuators, or solenoids. In addition, the pneumatic signal generator 315 can be adapted to send/receive signals to a source of regulated fluid (not shown in FIG. 3; similar to the source 209 of regulated fluid shown in FIG. 5A and FIG. 5B). The high-frequency pneumatic signal causes a pressure wave (or series of waves, or flow) of regulated fluid (such as a pulse of compressed air) to enter the interior 322 of the pneumatic passage 316 at the back end 320 of the pneumatic passage 316 and flow toward the front end 321 of the pneumatic passage 316 in the direction of the arrow. The regulated fluid then passes or flows through the interior 322 along a flow path 323.

A reference pressure sensing element 313 (for example, the reference pressure sensing element 207 in FIG. 2A) can be positioned parallel to the flow path 323 of the pneumatic passage 316, perpendicular to the flow path 323 of the pneumatic passage 316, or at an angle with respect to the flow path 323 of the pneumatic passage 316. The reference pressure sensing element 313 can be a pressure transducer but is not limited to pressure transducers.

The reference pressure sensing element 313 can be in fluid communication with the interior wall 318 of the pneumatic passage 316. The reference pressure sensing element 313 can be disposed on the interior 322 of the pneumatic passage 316 and along the flow path 323. In some embodiments, the reference pressure sensing element 313 can be flush with an interior wall 318 of the pneumatic passage 316 such that at least a portion of the reference pressure sensing element 313 is disposed at a location on the interior wall 318 of the pneumatic passage 316. In some embodiments, the reference pressure sensing element 313 can be proximally located and in fluid communication with an interior wall 318 of the pneumatic passage 316. The location of the reference pressure sensing element 313 can be accomplished by insertion of reference pressure sensing element 313 through a cavity into the pneumatic passage 316. The reference pressure sensing element 313 can be adapted to read, measure, or otherwise determine a reference pressure signal that corresponds to the reference pressure. The reference pressure sensing element 313 can also be adapted to output a signal corresponding to the reference pressure. This reference pressure is represented by, for example, curve 252 shown in FIGS. 2B and 2C.

Various components of the nozzle assembly 300, such as the pneumatic signal generator 315 and the reference pressure sensing element 313, can be coupled to a controller (not shown; same as or similar to controller 213). The controller can include a processor that performs operations and methods during use of the device for characterizing the dynamic response of a pressure measurement system. As shown in FIG. 6, the reference pressure sensing element 313 and other components of the device (for example, hand-held device 610) for characterizing the dynamic response of a pressure measurement system can be coupled via an electrical cable 612 to a controller (not shown). In addition, the tubing 611 couples the pneumatic signal generator 315 to a source of regulated fluid such as compressed air.

The nozzle assembly 300 further includes an inlet port 314a for introducing a regulated fluid into the pneumatic passage 316 at the back end 320 of the nozzle assembly 300. The inlet port 314a is coupled to, and in fluid communication with, the pneumatic passage 316 via components of the pneumatic signal generator 315. The inlet port 314a is also coupled to, and in fluid communication with, the source (not shown) of regulated fluid such as compressed fluid. The nozzle assembly 300 further includes an outlet port 314b for regulated fluid to exit the nozzle assembly 300. The outlet port 314b is coupled to, and in fluid communication with, the pneumatic passage 316 via components of the pneumatic signal generator 315.

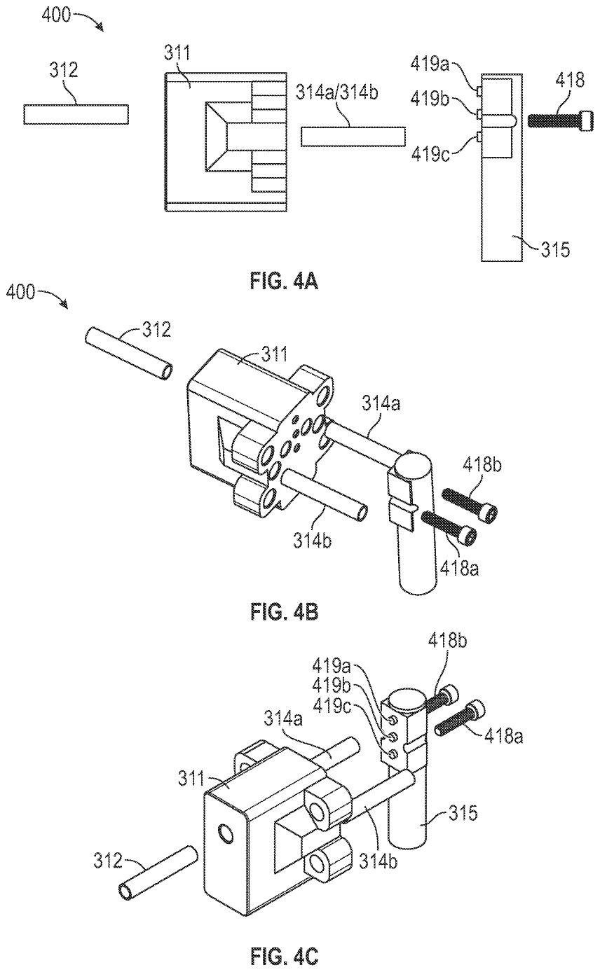

FIG. 4A is a partially exploded side view of a nozzle assembly 400 of a device for characterizing the dynamic response of a pressure measurement system according to at least one embodiment of the present disclosure. FIGS. 4B and 4C are partially exploded perspective views of the nozzle assembly 400 shown in FIG. 4A according to at least one embodiment of the present disclosure. The nozzle assembly 400 can be utilized with any suitable embodiment described herein, such as device 201, device 500, device 550, and hand-held device 610.

The nozzle tip 312, nozzle housing 311, inlet port 314a, outlet port 314b, and the pneumatic signal generator 315 of the nozzle assembly 400 are described above with respect to nozzle assembly 300. Screws 418a, 418b (collectively, screws 418) can be utilized to couple the pneumatic signal generator 315 to the nozzle housing 311 by a threaded connection. Additionally, or alternatively, a welded connection or pins can be utilized to couple the pneumatic signal generator 315 to the nozzle housing 311. A plurality of ports 419a-419c (collectively 419) are valve inlet/outlet ports that are utilized, for example, to allow passage of regulated fluid into and out of various components of the nozzle assembly 400.

FIG. 5A is a cross-sectional view of an illustrative, but non-limiting, device 500 for characterizing the dynamic response of a pressure measurement system according to at least one embodiment of the present disclosure. As shown, the device 500 (or characterization device) is in the form of a hand-held device. An exemplary, but non-limiting, illustration of the device 500 in use is the hand-held device 610 shown in FIG. 6.

The device 500 includes a nozzle assembly, such as nozzle assembly 300 described with respect to FIGS. 3A-3C or nozzle assembly 400 described with respect to FIGS. 4A-4C. The device 500 includes a main body portion 505 extending toward a handle portion 510 having a base 515, a front wall 520a, and a back wall 520b. The handle portion 510 includes a trigger assembly 524 along the front wall 520a of the device 500. The trigger assembly 524 is coupled to a trigger switch 523 and is coupled to a controller of on-board control interface 526. The trigger assembly causes or initiates an action by the controller of the on-board control interface 526. Such actions include, for example, for initiating an action such as reading (for example, receiving, collecting, measuring, or determining) a pressure; sending and/or receiving signals; delivering a regulated fluid to the pneumatic passage 316; reading (for example, receiving, collecting, measuring, or determining) an output of the reference pressure sensing element 313; producing a calibrated pressure or dynamically characterized pressure; reading (for example, receiving, collecting, measuring, or determining) a second output from the pressure sensor (for example, sensor 205) of the test article (for example, test article 202 or test article 601); or combinations thereof, among other actions.

The controller of on-board control interface 526 (further discussed below) can electronically access the output (pressure signal) of the pressure sensor (for example, sensor 205) of the test article (for example, test article 202 or test article 601) by use of a processor of the controller. Additionally, or alternatively, the reference pressure sensing element 313 can measure the pressure experienced by the pressure sensor (for example, sensor 205).

Below the trigger assembly 524 is located a component 522 to be held or gripped by a user. In some embodiments, and where the device 500 is to be mounted onto a surface of the test article, component 522 can be replaced with a mount or other suitable component. The mount can be adapted to be placed on, mounted on, or secured to a test article (for example, test article 202 or test article 601).

At the base 515 of the device 500 is disposed a pneumatic bulkhead fitting 527 used to couple components of the device 500 with a source 209 of regulated fluid (such as compressed fluid) via a tubing 511 or pneumatic passage (for example, tubing 611 shown in FIG. 6). As such, the pneumatic passage 316 is in fluid communication with the source 209 of regulated fluid via the pneumatic signal generator 315. An electrical connector 528 is also disposed at the base 515 of the device 500. The electrical connector 528 can be utilized to couple various components—such as the transducer, pneumatic signal generator 315, among other components—of the device 500 with an external controller 530 to the device 500. The device 500 can be coupled to the external controller 530 by an electrical cable 512 (for example, electrical cable 612). Additionally, or alternatively, the device 500 can be free of the electrical cable 512 such that the device can be configured to communicate wirelessly with, for example, a data input/output device (for example, external controller 530).

The main body portion 505 includes the nozzle assembly 300 (or nozzle assembly 400) positioned along the front wall 520a of the device 500. An on-board control interface 526 (or control module) is disposed nearer to the back wall 520b of the device 500. The on-board control interface 526 can include, inter alia, a controller (for example, controller 213), a central processing unit (CPU), computer system, or combinations thereof.

The on-board control interface 526 can be used to direct operation of the CPU for controlling various operations and actions of the device 500 such as sending and receiving commands or instructions when the trigger switch 523 is actuated. The on-board control interface 526 can be coupled to an input/output device. Optionally, the device 500 can include a display screen 525, such as a liquid crystal display screen, as an output device to display information and data to a user. Such information and data can include, but is not limited to, one or more of the following:
(a) Output from the pressure sensor (for example, the sensing system to be characterized 204) of the test article (for example, test article 202 or test article 601).
Such output can be an uncalibrated pressure signal;
(b) Output from the reference pressure sensing element 313. Such output can be a reference pressure signal that corresponds to a pressure of the regulated fluid;
(d) Output from other suitable components such as output from the pneumatic signal generator 315.

In some embodiments, the device 500 can be configured to communicate wirelessly with, for example, a data input/output device.

Referring back to the controller (for example, controller 213) of the on-board control interface 526, the controller can allow a user to gain access to and operate the device 500. The controller includes a processor (for example, processor 214), memory (for example, memory 215), and support circuits (for example, support circuits 216). The processor (for example, processor 214) may be one of any form of general purpose microprocessor, or a general purpose central processing unit (CPU), each of which can be used in an industrial setting, such as a programmable logic controller (PLC), supervisory control and data acquisition (SCADA) systems, or other suitable industrial controller. The controller (for example, controller 213) can perform one or more operations of methods described herein.

The memory (for example, memory 215) is non-transitory and may be one or more of readily available memory such as random access memory (RAM), read only memory (ROM), or any other form of digital storage, local or remote. The memory (for example, memory 215) contains instructions, that when executed by the processor (for example, processor 214), facilitate the operation of the device 500 of FIG. 5A (and the operation of the device 550 of FIG. 5B described below), operations of the device 500 (and the device 550 described below), and one or more operations of methods described herein. The instructions in the memory (for example, memory 215) can be in the form of a program product such as a program that implements the method of the present disclosure. The program code of the program product may conform to any one of a number of different programming languages. Illustrative, but non-limiting, examples of computer-readable storage media include: (i) non-writable storage media (for example, read-only memory devices within a computer such as CD-ROM disks readable by a CD-ROM drive, flash memory, ROM chips, or any type of solid-state non-volatile semiconductor memory) on which information is permanently stored; and (ii) writable storage media (for example, floppy disks within a diskette drive or hard-disk drive or any type of solid-state random-access semiconductor memory) on which alterable information is stored. Such computer-readable storage media, when carrying computer-readable instructions that direct the functions of, for example, methods described herein, are examples of the present disclosure. In one example, embodiments of the disclosure may be implemented as the program product stored on a computer-readable storage media (for example, memory) for use with a computer system (not shown). The program(s) of the program product define functions of the disclosure, described herein.

As a non-limiting example, the controller (for example, controller 213) and/or the processor thereof (for example, processor 214) of the on-board control interface 526 can determine a calibrated pressure or dynamically characterized pressure based on a reference pressure signal (for example, output from the reference pressure sensing element 313) and an uncalibrated pressure signal (for example, output from the sensing system to be characterized 204 of the test article 202). Here, and in some embodiments, the controller (or a component thereof, such as processor 214) can determine a mathematical function that calculates the calibrated pressure or dynamically characterized pressure based on, for example, the geometry of the tubing (for example, tubing 102) and its associated mathematical function that imposes distortions on pressure signals traveling through the tubing. That is, the mathematical function can be used to determine what the pressure signal should be on the measurement surface 104.

FIG. 5B is a cross-sectional view of an illustrative, but non-limiting, device 550 for characterizing the dynamic response of a pressure measurement system according to at least one embodiment of the present disclosure. As shown, the device 550 (or characterization device) is in the form of a hand-held device.

The device 550 includes many of those elements and features described above with respect to device 500 of FIG. 5A, and operation of the device 550 can be similar to operation of the device 500. The device 550 further includes an internal tank 552 in which regulated fluid (for example, compressed air) can be stored. Although device 550 is shown to include tubing connected to the source 209 of regulated fluid, the internal tank 552 can enable the device to be free of the tubing 511 and free of the connection to the source 209 of regulated fluid. For example, and besides the internal tank 552, the device 550 can further include a compact pump (e.g., an air pump) which can enable a stand-alone pneumatic system. This addition can further enhance the device's functionality by making the pneumatic elements self-contained, adding convenience and flexibility to its operation The device 550 can be used in situations where, for example, the tubing/sensor configurations being characterized (for example, tubing 102 and pressure transducer 101) exhibit a substantial internal volume. The inclusion of the internal tank 552 can help ensure that the generated pneumatic pressure pulse aligns precisely (or substantially precisely) with the intended pulse shape. Accordingly, use of the internal tank 552 can help ensure accurate and reliable measurements when the tubing/sensor configurations being characterized exhibit a substantial internal volume.

The presence of the internal tank 552 can also be beneficial when the device 550 is utilized for detecting leaks in a tubing system. By incorporating the internal tank 552, a larger volume of tubing in the sensing system to be characterized 204 can be filled without a significant drop in pressure within the entire system, thereby providing an effective method to detect leaks within the tubing system being characterized. Accordingly, inclusion of the internal tank 552 can enhance the performance and reliability of the device 550.

With respect to device 500 of FIG. 5A, the device 500 can be utilized in applications where, for example, the volume of the tubing/pressure sensor configuration being characterized (for example, tubing 102 and pressure transducer 101) is relatively low. Here, the device 500 can be smaller in size relative to the device 550 by, for example, eliminating the internal tank 552. Accordingly, and in some embodiments, the device 500 can have a more compact design, making the hand-held device more lightweight, portable, and user-friendly without compromising its performance and functionality. By tailoring the device 500 to suit specific low-volume applications, the device 500 can serve as a versatile tool that can be efficiently utilized in various contexts.

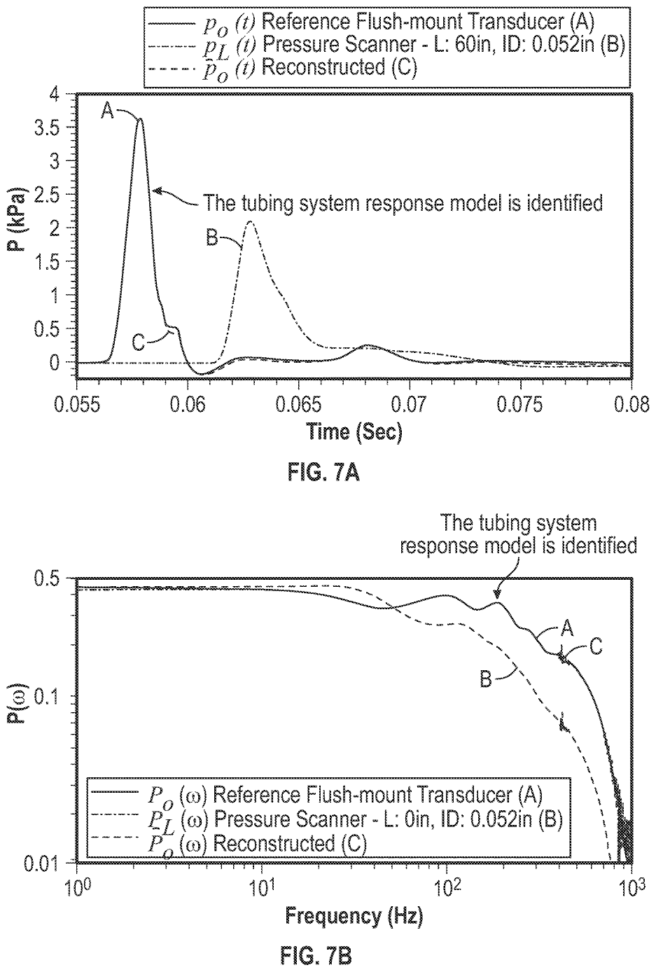

FIG. 6 is an illustration of an example device for characterizing the dynamic response of a pressure measurement system, shown as a hand-held device 610 (or hand-held characterization device), in operation according to at least one embodiment of the present disclosure. Hand-held device 610 can represent embodiments of device 500 and device 550 shown in FIGS. 5A and 5B, respectively. FIGS. 7A and 7B show exemplary data collected by operation of a device for characterizing the dynamic response of a pressure measurement system according to at least one embodiment of the present disclosure. The hand-held device 610 enables a user to measure, determine, or otherwise characterize a sensing system located in a test article 601. As shown in the illustration of FIG. 6, the display screen 525 (described above) is located on the back end of the hand-held device 610. The display screen 525 displays information and data to a user.

The test article 601 has an integrated pressure tap 602. As described above, the test article 601 includes a sensing system to be characterized (for example, the sensing system to be characterized 204). The sensing system to be characterized can be located directly under the pressure tap 602, within the test article 601, and/or outside of the test article 601.

The sensing system to be characterized can include a conventional remotely measured pressure sensor (for example, pressure transducer 101 or sensor 205) disposed within the test article 601 or outside of the test article 601. This remotely measured pressure sensor can be located some distance away from a pressure measurement point by a tubing (for example, tubing 102). In some embodiments, this tubing can be short (on the order of a few millimeters) or several meters long.

While the tubing serves to isolate expensive and fragile pressure transducers from heat, contamination, and physical contact with the measurement point, the tubing causes pneumatic distortions such as time lag and amplitude attenuation/resonance between the surface port (for example, surface port 103) and the pressure sensor (for example, pressure transducer 101 or sensor 205). These, and other distortions, severely limit the usefulness of pressure measurements to averaged, steady data. Embodiments described herein overcome such deficiencies and enable dynamic measurements.

In operation, for example, a user holds the hand-held device 610 and guides the nozzle tip 312 of the hand-held device 610 toward a pressure tap 602 of the test article 601. In embodiments where devices described herein are mountable, suitable operations can be performed to mount the device described herein to the test article 601. The test article 601, in this example, is an aerodynamic surface (for example, an aircraft wing or a flap). At or near the pressure tap 602 of the test article 601 is a sensing system to be characterized (for example, the sensing system to be characterized 204, such as a third-party pressure sensor that suffers from pneumatic distortions). As described above, the sensing system to be characterized includes a pressure sensor, such as pressure transducer 101 or sensor 205.

After the nozzle tip 312 is placed at, near, or over a pressure tap 602 of the test article 601, the user can depress the trigger assembly 524 (not shown in FIG. 6, but located behind the index finger of the user in the illustration) causing various actions to be performed. Such actions include, but are not limited to, generating a pulse of regulated fluid via the pneumatic signal generator 315, measuring a reference pressure at the reference pressure sensing element 313, and measuring a pressure at the sensor (transducer) of the sensing system to be characterized.

Referring again to FIGS. 7A and 7B, Curve A shows reference pressure data that is collected, measured, or otherwise determined as output by the reference pressure sensing element 313. Such reference pressure data can be a reference pressure signal that corresponds to a pressure of the regulated fluid.

Curve B shows the pressure data that is collected, measured, or otherwise determined as output of the pressure sensor of the sensing system to be characterized (for example, sensor 205 of the sensing system to be characterized 204). Such data shown as Curve B can be an uncalibrated pressure signal.

Curve C represents a reconstructed pressure curve which represents a calibrated pressure or dynamically characterized pressure. The calibrated pressure or dynamically characterized pressure represented by Curve C takes into account the data shown by Curve A and Curve B and is constructed by an algorithm to determine the calibrated pressure or dynamically characterized pressure.

Embodiments described herein also relate to methods, such as methods of using devices of the present disclosure. Methods can enable, for example, determination of a calibrated pressure or dynamically characterized pressure, the characterization of dynamic pressure sensing systems, or combinations thereof.

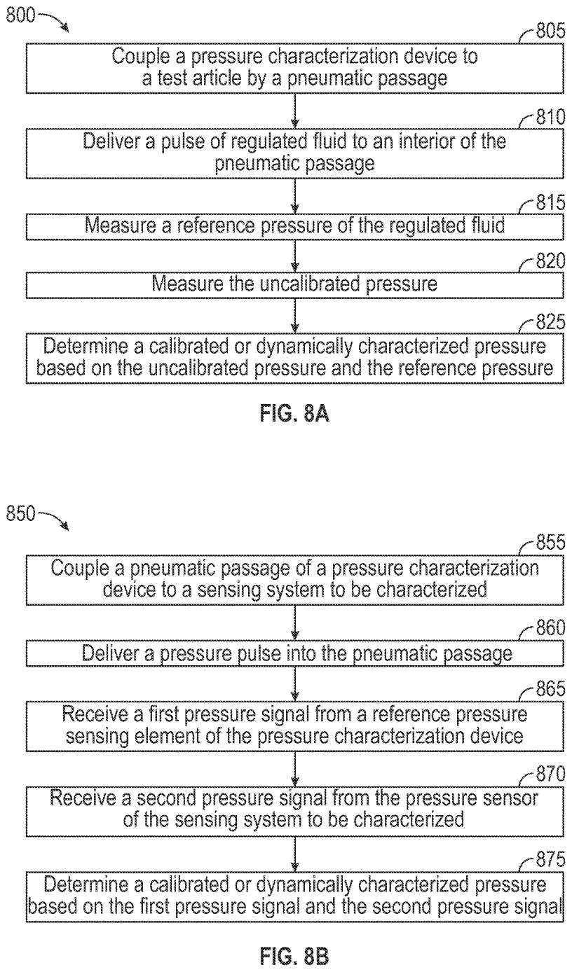

FIG. 8A shows selected operations of a method 800 for characterizing a dynamic response of a pressure sensing system. The method 800 can begin with coupling a pressure characterization device (for example, device 201, device 500, device 550, or hand-held device 610) to a test article (for example, test article 202 or test article 601) by a pneumatic passage (for example, pneumatic passage 316) at operation 805.

As described herein, the pressure characterization device includes the pneumatic passage 316. The pneumatic passage 316 includes a front end 321, a back end 320, and an interior 322. The pressure characterization device also includes a reference pressure sensing element 313 disposed on the interior 322. The reference pressure sensing element 313 can be a pressure transducer. The test article includes a pressure sensing system (for example, the sensing system to be characterized 204, such as a third-party pressure sensor that suffers from pneumatic distortions). The pressure sensing system includes a pressure sensor, such as pressure transducer 101 or sensor 205.

The method 800 can further include delivering a pulse of regulated fluid to the interior of the pneumatic passage at operation 810. Here, the pulse of regulated fluid can be generated by the pneumatic signal generator 206 (or pneumatic signal generator 315), causing a pulse of regulated fluid to be sent to enter the interior 322 of the pneumatic passage 316 (or pneumatic passage 208) at the back end 320 of the pneumatic passage 316 and flow toward the front end 321 of the pneumatic passage 316. The pulse of regulated fluid can be a pressure wave (or series of waves, or flow) of regulated fluid (such as a pulse of compressed air). In some embodiments, the pulse of regulated fluid can be delivered to the interior 322 of the pneumatic passage 316 by actuation of a valve or fluidic actuator located proximate to the back end 320 of the pneumatic passage 316.

In use, operation 810 can take the following illustrative, but non-limiting, form. After placing the nozzle on the pressure tap/surface port (for example, operation 805), the user presses on the trigger to start the sequence. The controller (for example, controller 213), sensing the trigger has been pressed, starts taking measurements from a reference pressure sensing element (for example, reference pressure sensing element 207, 313) and remote sensors (for example, sensor 205). The controller (for example, controller 213) activates the pneumatic signal generator (for example, pneumatic signal generator 206, 315) that is in pneumatic connection with the source 209 of regulated fluid. The activation of the pneumatic signal generator 206 (or pneumatic signal generator 315) allows for the regulated fluid to enter the pneumatic passage 316 (or pneumatic passage 208) and cause a pressure pulse. In some embodiments, and in addition to the introduction of the fluid that causes the rise in the pressure, the pneumatic signal generator 206 (or pneumatic signal generator 315) can also induce pressure waves by use of piezoelectric vibrations or other suitable ways.

The method 800 can further include measuring the reference pressure of the regulated fluid using the reference pressure sensing element 313 (for example, a pressure transducer) at operation 815.

The method 800 can further include measuring the uncalibrated pressure using the pressure sensor of the test article at operation 820. The uncalibrated pressure in the test article is induced when the reference pressure signal generated from the device is introduced to the surface tap of the tubing system being characterized. This uncalibrated pressure is that measured by the measurement transducer (at the end of the tubing) and has not yet been corrected for the pneumatic distortions due the tubing passages.

As described herein, the test article (for example, test article 202 or test article 601) includes the pressure sensing system (for example, the sensing system to be characterized 204), and the pressure sensing system includes the pressure sensor (for example, pressure transducer 101 or sensor 205) of the test article. It is this pressure sensor that can be used to measure the uncalibrated pressure at operation 825.

The method 800 can further include determining a calibrated pressure or dynamically characterized pressure based on the uncalibrated pressure and the reference pressure at operation 825. One or more operations of method 800 can be performed by a controller (for example, controller 213) as described herein.

FIG. 8B shows selected operations of a method 850 for characterizing a dynamic response of a pressure sensing system. Although method 850 is described with reference to device 500, it should be understood that other devices of the present disclosure can be utilized.

The method 850 can begin with coupling a pneumatic passage 316 of a pressure characterization device (for example, device 201, device 500, device 550, or hand-held device 610) to a sensing system to be characterized 204 (such as a third-party pressure sensor that suffers from pneumatic distortions) at operation 855. The sensing system to be characterized 204 is part of a test article (for example, test article 202 or test article 601). The sensing system to be characterized 204 includes pressure sensor, such as pressure transducer 101 or sensor 205. The pneumatic passage 316 of device 500 includes a back end 320, a front end 321, and a flow path 323. As described herein, the device 500 includes a pneumatic signal generator 315, and the pneumatic signal generator 315 includes or is a valve (or actuator). This valve is located proximate to the back end 320 of the pneumatic passage 316, and is configured to cause a regulated fluid to enter the pneumatic passage 316 through the back end 320 of the pneumatic passage 316. The device 500 also includes a reference pressure sensing element 313 disposed in an interior 322 of the pneumatic passage and at a location between the front end 321 and the back end 320 of the pneumatic passage 316.

As also described herein, the device 500 is adapted to generate the regulated fluid and introduce the regulated fluid into the test article (for example, test article 202 or test article 601) via the pressure tap. The introduction of the regulated fluid to the system causes a rise in the pressure. This rise in the pressure is being measured by the two pressure sensors (for example, sensor 205 and reference pressure sensing element 313). The regulated fluid is characterized as having a reference pressure.

The method 850 can further include delivering a pressure pulse into the pneumatic passage at operation 860. Operation 860 can be the same as or similar to operation 805 of FIG. 8A.

The method 850 can further include receiving, from the reference pressure sensing element 313, a first pressure signal corresponding to the reference pressure at operation 865. The method 850 can further include receiving a second pressure signal from the pressure sensor (for example, pressure transducer 101 or sensor 205) of the sensing system to be characterized 204 at operation 870. This second pressure signal can correspond to the uncalibrated pressure.

The method 850 can further include determining a calibrated pressure or dynamically characterized pressure based on the first pressure signal and the second pressure signal at operation 875. One or more operations of method 850 can be performed by a controller (for example, controller 213) as described herein.

Embodiments described herein generally relate to devices for characterizing the dynamic response of a pressure measurement system. Embodiments described herein also generally relate to methods of using such devices. Embodiments described herein can enable characterization of the frequency response of a pressure measurement system to be utilized to compensate for pneumatic distortions caused by, for example, conventional pressure sensors of test articles. As a result, embodiments of the present disclosure can enable more precise measurements than conventional technologies.

### EMBODIMENTS LISTING

The present disclosure provides, among others, the following embodiments, each of which can be considered as optionally including any alternate embodiments:

Clause A1. A device to dynamically characterize a pressure measurement system, the device comprising:
a pneumatic passage comprising a front end, a back end, an interior, and a flow path;
a valve coupled to the back end of the pneumatic passage, the valve for permitting a regulated fluid to enter the flow path of the pneumatic passage;
a reference pressure sensing element disposed on the interior of the pneumatic passage and along the flow path of the pneumatic passage; and
a controller coupled to the reference pressure sensing element and the valve.

Clause A2. The device of Clause A1, further comprising a trigger assembly coupled to the controller, the trigger assembly configured to cause an action by the controller.

Clause A3. The device of Clause A2, wherein the action comprises:
delivering the regulated fluid to the pneumatic passage;
reading an output from the reference pressure sensing element;
producing a calibrated pressure or dynamically characterized pressure; or
combinations thereof.

Clause A4. The device of Clause A2 or Clause A3, wherein the front end of the pneumatic passage is adapted to be coupled to, or adapted to be in fluid communication with, a pressure sensor of the pressure measurement system of a test article, the pressure sensor configured to measure an uncalibrated pressure of the test article.

Clause A5. The device of Clause A4, wherein the pressure sensor of the test article is coupled to a measurement point of the test article by a tubing.

Clause A6. The device of Clause A4 or Clause A5, wherein the action comprises:
reading a first output from the reference pressure sensing element, the first output corresponding to a reference pressure;
reading a second output from the pressure sensor of the test article, the second output corresponding to the uncalibrated pressure; and
determining a calibrated pressure or dynamically characterized pressure based on the first output and the second output.

Clause A7. The device of any one of Clauses A1-A6, wherein the controller is configured to:
receive a first pressure signal from the reference pressure sensing element;
receive a second pressure signal from a pressure sensor; and
produce a calibrated or compensated output signal based on the first pressure signal and the second pressure signal.

Clause A8. The device of any one of Clauses A1-A7, wherein the reference pressure sensing element is configured to:
measure a first pressure signal corresponding to a pressure of the regulated fluid; and
measure, when the device is coupled to a pressure sensor of a test article, a second pressure signal corresponding to a pressure measured using the pressure sensor of the test article.

Clause A9. The device of any one of Clauses A1-A8, wherein the device is portable, hand-held, or both.

Clause A10. The device of any one of Clauses A1-A9, wherein the valve is a solenoid valve, an electric valve, or an actuator.

Clause A11. The device of any one of Clauses A1-A10, wherein the device is a device for measuring pressure.

Clause B1. A device for performing dynamic pressure characterization, comprising:
a pneumatic passage adapted to be coupled to a test article, the test article having a pressure sensor, the pneumatic passage comprising a front end, a back end, and an interior, the interior of the pneumatic passage comprising a flow path;
a valve coupled proximate to the back end of the pneumatic passage;
a source of regulated fluid in fluid communication with the pneumatic passage, the valve, or combinations thereof;
a reference pressure sensing element disposed on the interior of the pneumatic passage and along the flow path between the front end and the back end of the pneumatic passage; and
a controller configured to:
   receive a reference pressure signal from the reference pressure sensing element, the reference pressure signal corresponding to a pressure of the regulated fluid;
   receive an uncalibrated pressure signal from the pressure sensor of the test article; and
   determine a calibrated pressure or dynamically characterized pressure based on the reference pressure signal and the uncalibrated pressure signal.

Clause B2. The device of Clause B1, wherein the pressure sensor of the test article is coupled to a measurement point of the test article by a tubing.

Clause B3. The device of Clause B1 or Clause B2, further comprising a trigger assembly coupled to the controller, the trigger assembly configured to cause an action by the controller.

Clause B4. The device of Clause B3, wherein the action comprises:
delivering a regulated fluid to the interior of the pneumatic passage;
reading a first output from the reference pressure sensing element;
reading a second output from the pressure sensor of the test article; and
producing the calibrated pressure or dynamically characterized pressure based on the first output and the second output.

Clause B5. The device of any one of Clauses B1-B4, wherein the device is portable, hand-held, or both.

Clause B6. The device of any one of Clauses B1-B5, wherein the device is a device for performing dynamic pressure measurements, a device for performing dynamic pressure measurements, or combinations thereof.

Clause C1. A method for characterizing a dynamic response of a pressure sensing system, comprising:
coupling a pressure characterization device to a test article by a pneumatic passage, wherein:
   the test article comprises the pressure sensing system, the pressure sensing system comprising a pressure sensor; and
   the pressure characterization device comprises:
      the pneumatic passage, the pneumatic passage comprising a front end, a back end, and an interior; and
      a pressure transducer disposed on the interior of the pneumatic passage;
delivering a pulse of regulated fluid to the interior of the pneumatic passage, the regulated fluid having a reference pressure;
measuring the reference pressure using the pressure transducer; measuring an uncalibrated pressure using the pressure sensor of the test article; and
determining a calibrated pressure or dynamically characterized pressure based on the uncalibrated pressure and the reference pressure.

Clause C2. The method of Clause C1, wherein the pressure sensor of the test article is coupled to a measurement point of the test article by a tubing.

Clause C3. The method of Clause C1 or Clause C2, further comprising delivering the regulated fluid to the interior of the pneumatic passage by actuation of a valve or a fluidic actuator located proximate to the back end of the pneumatic passage.

Clause C4. The method of Clause C3, wherein the valve or fluidic actuator located proximate to the back end of the pneumatic passage is a solenoid valve, an electric valve, or an actuator.

Clause C5. The method of any one of Clauses C1-C4, wherein the pressure characterization device is portable, hand-held, or both.

Clause C6. The method of any one of Clauses C1-C5, wherein the method is a method for dynamically measuring pressure, statically measuring pressure, or combinations thereof.

Clause D1. A method for characterizing a dynamic response of a pressure sensing system, comprising:
coupling a pneumatic passage of a pressure characterization device to a sensing system to be characterized, the sensing system to be characterized comprising a pressure sensor that measures an uncalibrated pressure, wherein the pressure characterization device comprises:
   the pneumatic passage, the pneumatic passage comprising a front end, a back end, a flow path;
   a valve located proximate to the back end of the pneumatic passage, the valve configured to cause a regulated fluid to enter the pneumatic passage through the back end of the pneumatic passage,
   wherein a reference pressure sensing element disposed at a location between the front end and the back end of the pneumatic passage; and
delivering the regulated fluid into the pneumatic passage, the regulated fluid having a reference pressure;
receiving, from the reference pressure sensing element, a first pressure signal corresponding to the reference pressure;
receiving, from the pressure sensor, a second pressure signal corresponding to the uncalibrated pressure; and
determining a pressure based on the first pressure signal and the second pressure signal.

Clause D2. The method of Clause D1, wherein the method is a method for measuring pressure.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a formulation, a composition, an element or a group of elements is preceded with the transitional phrase “comprising,” it is understood that we also contemplate the same formulation, composition or group of elements with transitional phrases “consisting essentially of,” “consisting of,” “selected from the group of consisting of,” or “Is” preceding the recitation of the formulation, composition, element, or elements and vice versa, for example, the terms “comprising,” “consisting essentially of,” “consisting of” also include the product of the combinations of elements listed after the term.

For the purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, embodiments comprising “a pneumatic passage” include embodiments comprising one, two, or more pneumatic passages, unless specified to the contrary or the context clearly indicates only one pneumatic passage is included.

While the foregoing is directed to embodiments of the present disclosure, other and further embodiments of the disclosure may be devised without departing from the basic scope thereof, and the scope thereof is determined by the claims that follow.

What is claimed is:

1. A device to dynamically characterize a pressure measurement system, the device comprising:
a pneumatic passage comprising a front end, a back end, an interior, and a flow path;
a valve coupled to the back end of the pneumatic passage, the valve for permitting a regulated fluid to enter the flow path of the pneumatic passage;
a reference pressure sensing element disposed on the interior of the pneumatic passage and along the flow path of the pneumatic passage; and
a controller coupled to the reference pressure sensing element and the valve.

2. The device of claim 1, further comprising a trigger assembly coupled to the controller, the trigger assembly configured to cause an action by the controller.

3. The device of claim 2, wherein the action comprises:
delivering the regulated fluid to the pneumatic passage;
reading an output from the reference pressure sensing element;
producing a calibrated pressure or dynamically characterized pressure; or combinations thereof.

4. The device of claim 2, wherein the front end of the pneumatic passage is adapted to be coupled to, or adapted to be in fluid communication with, a pressure sensor of the pressure measurement system of a test article, the pressure sensor configured to measure an uncalibrated pressure of the test article.

5. The device of claim 4, wherein the pressure sensor of the test article is coupled to a measurement point of the test article by a tubing.

6. The device of claim 5, wherein the action comprises:
reading a first output from the reference pressure sensing element, the first output corresponding to a reference pressure;
reading a second output from the pressure sensor of the test article, the second output corresponding to the uncalibrated pressure; and
determining a calibrated pressure or dynamically characterized pressure based on the first output and the second output.

7. The device of claim 1, wherein the controller is configured to:
receive a first pressure signal from the reference pressure sensing element;
receive a second pressure signal from a pressure sensor; and
produce a calibrated or compensated output signal based on the first pressure signal and the second pressure signal.

8. The device of claim 1, wherein the reference pressure sensing element is configured to:
measure a first pressure signal corresponding to a pressure of the regulated fluid; and
measure, when the device is coupled to a pressure sensor of a test article, a second pressure signal corresponding to a pressure measured using the pressure sensor of the test article.

9. The device of claim 1, wherein the device is portable, hand-held, or both.

10. The device of claim 1, wherein the valve is a solenoid valve, an electric valve, or an actuator.

11. A device for performing dynamic pressure characterization, comprising:
a pneumatic passage adapted to be coupled to a test article, the test article having a pressure sensor, the pneumatic passage comprising a front end, a back end, and an interior, the interior of the pneumatic passage comprising a flow path;
a valve coupled proximate to the back end of the pneumatic passage;
a source of regulated fluid in fluid communication with the pneumatic passage and the valve;
a reference pressure sensing element disposed on the interior of the pneumatic passage and along the flow path between the front end and the back end of the pneumatic passage; and
a controller configured to:
receive a reference pressure signal from the reference pressure sensing element, the reference pressure signal corresponding to a pressure of the regulated fluid;
receive an uncalibrated pressure signal from the pressure sensor of the test article; and
determine a calibrated pressure or dynamically characterized pressure based on the reference pressure signal and the uncalibrated pressure signal.

12. The device of claim 11, wherein the pressure sensor of the test article is coupled to a measurement point of the test article by a tubing.

13. The device of claim 11, further comprising a trigger assembly coupled to the controller, the trigger assembly configured to cause an action by the controller.

14. The device of claim 13, wherein the action comprises:
delivering a regulated fluid to the interior of the pneumatic passage;
reading a first output from the reference pressure sensing element;
reading a second output from the pressure sensor of the test article; and
producing the calibrated pressure or dynamically characterized pressure based on the first output and the second output.

15. The device of claim 11, wherein the device is portable, hand-held, or both.

16. A method for characterizing a dynamic response of a pressure sensing system, comprising:
coupling a pressure characterization device to a test article by a pneumatic passage, wherein:
the test article comprises the pressure sensing system, the pressure sensing system comprising a pressure sensor; and
the pressure characterization device comprises:
the pneumatic passage, the pneumatic passage comprising a front end, a back end, and an interior; and
a pressure transducer disposed on the interior of the pneumatic passage;
delivering a pulse of regulated fluid to the interior of the pneumatic passage, the regulated fluid having a reference pressure;
measuring the reference pressure using the pressure transducer;
measuring an uncalibrated pressure using the pressure sensor of the test article; and
determining a calibrated pressure or dynamically characterized pressure based on the uncalibrated pressure and the reference pressure.

17. The method of claim 16, wherein the pressure sensor of the test article is coupled to a measurement point of the test article by a tubing.

18. The method of claim 16, further comprising delivering the regulated fluid to the interior of the pneumatic passage by actuation of a valve or a fluidic actuator located proximate to the back end of the pneumatic passage.

19. The method of claim 18, wherein the valve or fluidic actuator located proximate to the back end of the pneumatic passage is a solenoid valve, an electric valve, or an actuator.

20. The method of claim 16, wherein the pressure characterization device is portable, hand-held, or both.
